(19) United States
(12) Patent Application Publication
(10) Pub. No.: US 2024/0322358 A1
(43) Pub. Date: Sep. 26, 2024

(54) WALL FOR THE PASSAGE OF GASES EMERGING FROM A BATTERY CELL, BATTERY, MOTOR VEHICLE, AND METHOD

(71) Applicant: AUDI AG, Ingolstadt (DE)

(72) Inventor: Lars KRUSE, Kosching (DE)

(73) Assignee: AUDI AG, Ingolstadt (DE)

(21) Appl. No.: 18/443,576

(22) Filed: Feb. 16, 2024

(30) Foreign Application Priority Data
Mar. 21, 2023 (DE) 102023107088.6

(51) Int. Cl. H01M 50/375; H01M 50/249; H01M 50/289

(52) U.S. Cl. CPC H01M 50/375; H01M 50/249; H01M 50/289; H01M 2200/10; H01M 2220/20

(57) ABSTRACT

A wall for arrangement on at least one battery cell and for the passage of gases emerging from the at least one battery cell. The wall has an opening area through which, in case of gas emerging from the at least one battery cell, in which gas emerges from the at least one battery cell, the emerging gas can be conducted through the wall. The opening area includes an opening device which is fluid-tight in a closed state and which is designed to carry out an exothermic chemical reaction triggerable by an activation event, by which at least part of the opening device can be melted, due to which the opening device passes from the closed state into an open state, in which the gas emerging from the at least one battery cell can be conducted through the wall.

### FIELD

The invention relates to a wall for arrangement on at least one battery cell and for the passage of gases emerging from the at least one battery cell, wherein the wall has an opening area through which, in case of gas emerging from the at least one battery cell, in which gas emerges from the at least one battery cell, the emerging gas can be conducted through the wall. Furthermore, the invention also relates to a battery for a motor vehicle, a motor vehicle, and a method for the passage of gases emerging from at least one battery cell through a wall.

### BACKGROUND

In current battery systems, in particular for motor vehicles, there is a possibility that cells will outgas. This is the case in particular in case of thermal runaway of such a cell. In order to conduct the gas deliberately out of the battery housing, a degassing channel can be provided. The gas emerging from the cell is introduced therein and the gas is thereby discharged from the battery housing and in particular from the motor vehicle. The degassing channel is usually separated from the interior of the battery housing or prevents the gas introduced into the degassing channel from being able to spread through the rest of the interior of the battery housing.

One difficulty is in the design and formation of the opening area through which the gas emerging from the battery cell is to be introduced, for example, into the degassing channel or alternatively directly into the surroundings. If, for example, this is provided with a permanent opening, the remaining structure of the degassing channel or the battery housing is complex, since it has to be ensured that the interior of the battery housing is still reliably sealed and therefore protected from environmental influences. However, if the opening area is closed and, for example, designed as a kind of predetermined breaking point, there is a risk that this predetermined breaking point will not open reliably under certain circumstances in case of degassing. When degassing, cells release different amounts of energy depending on their charge level. If an opening is to be created during degassing, for example in the channel wall of a gas discharge channel, in order to introduce the gas therein, the problem is that in a cell with a low energy content, under certain circumstances not enough energy is released to “burn” such an opening into the channel wall. In this case, particles and hot gases would then spread within the battery system and could trigger further cell failures. In the case of cells with a high energy content, on the other hand, there is a risk that an excessively strong gas jet from the cell will burn away more structure from the wall than necessary and in an uncontrolled manner. There is also a general risk that it will not be opened immediately and that the outgassing cell will build up pressure in the battery system.

DE 10 2014 206 058 A1 describes a battery cell having a housing that has a housing opening having an opening area. The battery cell has a venting element which is arranged in the area of the housing opening and closes it in relation to the surroundings of the battery cell, wherein the venting element is designed to discharge a gas arising in the battery cell via a venting element opening to the surroundings of the battery cell in a critical operating state of the battery cell that differs from a normal operating state. The battery cell has a closure element which is arranged in the area of the opening area and closes the opening area at least partially circumferentially, wherein the closure element is designed to retain fire-enabling substances in the cell in the critical operating state and/or to provide a fire influencing substance influencing the fire behavior of combustible substances.

### SUMMARY

The object of the present invention is to provide a wall, a battery, a motor vehicle, and a method which, in a normal state, provide the best possible protection for the battery cells arranged in a battery housing from environmental influences and which, in case of gas emerging from a cell, enable the most reliable possible discharge of such a gas into the surroundings and/or into a gas discharge channel.

A wall according to the invention for arrangement on at least one battery cell and for the passage of gases emerging from the at least one battery cell has an opening area through which, in case of gas emerging from the at least one battery cell, in which gas emerges from the at least one battery cell, the emerging gas can be conducted through the wall. The opening area has an opening device which is fluid-tight in a closed state and which is designed to carry out an exothermic chemical reaction triggerable by an activation event, by which at least part of the opening device can be melted, due to which the opening device passes from the closed state into an open state, in which the gas emerging from the at least one battery cell can be conducted through the wall.

In the present case, the “burning through” of the wall in the opening area is not caused, or at least not exclusively, by the gas jet or gas flow emerging from the at least one battery cell, but rather by an exothermic chemical reaction that is carried out by an opening device in the opening area of the wall. The exothermic chemical reaction is triggered outside the battery cell and, for example, in the opening device. In other words, the exothermic chemical reaction does not mean the thermal runaway of a battery cell or the exothermic chemical reaction that occurs when a battery cell thermally runs away. This advantageous embodiment of the opening device allows the opening area to be made fluid-tight when this opening device is closed, so that particularly good protection of the battery cells in the interior of the battery housing is provided, and on the other hand, in case of degassing, reliable opening of the opening area can be ensured, especially opening which is independent of the energy content of the battery cell thermally running away and correspondingly also independent of the strength of the gas jet emerging from the at least one battery cell or the amount of gas emerging. This advantageously allows a reliable and controlled opening of the opening area of the wall in case of gas emerging in many different situations, i.e., both with fully charged cells and with slightly charged cells and also with different cell chemistries.

The wall can be, for example, a channel wall of an adjacent gas discharge channel. In this case, in the open state of the opening device, the gas emerging from the at least one battery cell can be conducted through the wall into the gas discharge channel and via this into the surroundings of the motor vehicle. The provision of a gas discharge channel is merely optional. The gas emerging from the at least one battery cell can also flow through the wall directly into the surroundings of the motor vehicle. In both cases, the wall can at the same time be a wall of a battery housing in which the battery cell is arranged. The wall can be, for example, a housing base or a housing cover of such a battery housing. The wall can, for example, separate an interior of a battery housing from the interior of the gas discharge channel or from the surroundings of the motor vehicle. The at least one battery cell is preferably arranged directly on this wall, for example having its releasable cell degassing opening facing toward the opening area of the wall.

The battery cell can therefore be arranged on the wall in such a way that its releasable gas outlet opening is directly opposite to the opening area of the wall. A gas emerging from the battery cell thus directly strikes the opening area of the wall. The impact of such a gas flow or gas jet on the opening area or on the opening device can, for example, also simultaneously represent the activation event that triggers the exothermic chemical reaction of the opening device. However, the activation event can also be defined differently, for example by an external control signal.

In a further advantageous embodiment of the invention, the opening device has a chamber having an interior and a chamber wall enclosing the interior, in particular made of metallic material, wherein an ignitable substance, in particular a powder mixture, is arranged in the interior, which is designed so that it carries out the exothermic chemical reaction upon ignition.

The opening device can, for example, have an upper part and a lower part, as explained in more detail later, which together form a cavity, which is also referred to in the present case as an interior and which is at least partially filled with the substance, which is preferably provided as a powder mixture. The substance is ignitable, i.e., the substance is activatable by supplying energy, in particular thermal energy, wherein the exothermic chemical reaction is triggered by ignition of the substance. The substance can also be flammable. The substance or the powder mixture can, for example, have a composition such that it can be set into a metal fire. This is particularly advantageous because very high temperatures can be generated, in particular of several hundred degrees Celsius and even over 1000 degrees Celsius. This in turn allows reliable melting through of the chamber wall, in particular the metallic chamber wall. For example, such a powder mixture can comprise a powder made up of at least one of the following materials: iron oxide, aluminum, aluminum oxide, and magnesium. For example, the substance can be a thermite. Thermite can, for example, be or comprise a mixture of iron (III) oxide and aluminum granules, which is also used, for example, for aluminum thermal welding or other thermite processes. Magnesium can be used here as a pyrotechnic igniting agent or also another pyrotechnic igniting agent or a mixture with other pyrotechnic igniting agents.

In general, the term thermite refers to free-flowing mixtures of more or less finely divided metals with certain metal oxides, which, after the reaction has been initiated by special pyrotechnic igniting agents, for example a mixture of barium peroxide and magnesium, or barium nitrate and fine-grained aluminum, react while developing extremely strong heat within a short time, for example approximately 2,400 degrees Celsius, and while forming the metal previously contained in the metal oxide.

To ignite the powder mixture, the opening device can also have an detonator. This can be integrated into the chamber wall, for example. This can comprise, for example, an ignition element or a glow element, e.g., a glow wire or a glow plug or the like.

Designing the chamber wall as a metallic chamber wall has the advantage that, on the one hand, it can be integrated particularly easily into the rest of the wall, which, for example, is also preferably formed from a metallic material as part of a battery housing. In addition, this can provide greater stability and robustness.

In a further advantageous embodiment of the invention, the activation event represents a heating of the opening device caused by a thermal runaway of the at least one battery cell, in particular wherein an ignition module of the opening device is triggerable by the heating, and the opening device is configured so that the substance is ignitable by the triggering of the ignition module. In particular, the thermal energy causing the heating can come from the battery cell thermally running away. For example, the gas jet emerging from the battery cell thermally running away, which in particular is typically very hot, can strike the chamber wall of the opening device and thereby heat it strongly. This can, for example, either initiate the chemical reaction of the substance directly or indirectly via the ignition module mentioned above, which can also be referred to as a detonator. In the first case, the wall can, for example, be designed in such a way that it can be easily penetrated by the gas jet emerging from the cell, so that it can strike the substance located in the interior of the chamber directly and thereby ignite it. However, the opening device preferably has an ignition module. This can be integrated into the chamber wall and can also be arranged directly opposite to the releasable degassing opening of the battery cell, in particular in relation to the intended installation position of the wall in a battery, so that the gas jet emerging from the cell strikes this ignition module. The ignition module can be triggered, for example, via an ignition channel by the hot gas flow from the cell. For example, the hot gas jet ignites the ignition module, which then ignites the substance in the opening device and thus triggers the chemical reaction. This means that the triggering of the chemical reaction is directly coupled to the outgassing of a cell. This also provides a passive triggering mechanism that manages without actuation.

In general, the ignition module, regardless of whether it is actuatable or not, can be designed in such a way that it ignites the substance located in the interior when the activation event occurs.

In a further advantageous embodiment of the invention, the opening device has an actuatable ignition module, wherein the activation event represents an actuation of the ignition module, in particular wherein the ignition module is designed such that when activated, it ignites the substance located in the interior.

In this example, the ignition module is now designed to be actuatable. The actuation can take place, for example, via a signal line. For example, this can be an electrical actuation of the ignition module. Such an actuation represents the activation event. Such an actuation of the ignition module can be provided, for example, by a control device. Such a control device can be designed to actuate the ignition module accordingly in case of a thermal runaway of a battery cell being detected. This advantageously also allows the ignition module to be triggered particularly early. For example, no gas has to emerge at all from the cell in question at this point in time. In addition, in case that a first battery cell thermally runs away, it is also possible to additionally actuate the ignition module, which is assigned to an adjacent battery cell of the battery cell thermally running away, so that this adjacent ignition module and correspondingly also the adjacent opening device can already be opened preventively, since in case of a thermal event it is very likely that it will spread to a neighboring cell.

In general, for example, if multiple battery cells are comprised by one battery, it can be provided that a specially provided opening area having an opening device is provided in the wall for each of these battery cells. Each battery cell can then be arranged accordingly at its assigned opening area, in particular as described for at least one battery cell, namely having the respective cell degassing opening facing toward the opening area and in particular the ignition module. However, it can also be provided that a common opening area having only a single opening device is provided for multiple battery cells at the same time. Then the opening device can also be an elongated opening device, for example, and multiple battery cells are accordingly arranged in the same opening area, so that, for example, the respective cell degassing openings are arranged directly opposite to the elongated opening area or the elongated opening device.

In a further advantageous embodiment of the invention, the opening device has a first shell and a second shell, each of which provides a part of the chamber wall and which are arranged opposite to one another and, for example, are joined together, wherein the first shell is provided for an arrangement facing toward the battery cell and the second shell is provided for an arrangement facing toward a gas discharge channel or the surroundings of the battery housing in which the at least one battery cell is arranged, wherein the first shell has a higher heat resistance than the second shell.

On the one hand, the chamber wall can be provided by two shells which are arranged opposite to one another and are joined together. The ignition module described above, whether actuatable or not, can be integrated into the first shell, for example. With respect to the intended installation position of the wall in a battery, the first shell accordingly faces toward the at least one battery cell and the second shell faces away from the at least one battery cell and, for example, faces toward a gas discharge channel or the surroundings of the battery housing.

It is now very advantageous if the first shell has a higher heat resistance than the second shell. This has the great advantage that the heat energy released during the exothermic chemical reaction can initially and primarily be used to ensure that the second shell opens or melts, in particular before the first shell opens or melts. This advantageously ensures opening to the outside or into the gas discharge channel first. The first shell does not necessarily have to be destroyed or melted solely by the energy released during the exothermic chemical reaction, but is penetrated by it with the aid of the incident gas flow. This allows particularly reliable opening of the opening device to be achieved. The fact that the first shell is designed having a higher heat resistance than the second shell can be provided in a variety of ways. For example, the first shell can be designed having a greater wall thickness than the second shell. Additionally or alternatively, the first shell can also be made of a different material than the second shell, for example of a material having a higher melting point than the material of the second shell. There are also, for example, special coatings that can be used to increase the heat resistance. For example, the first shell can be provided with such a coating, in particular on a side facing toward the interior of the chamber. Overall, the first and second shells can be selected and designed based on the material selection, in particular material and material thickness, and/or coating, so that opening to the outside is ensured first, i.e., the second shell can be opened reliably and first.

The chamber wall does not necessarily have to be manufactured from two separate shells joined together, but can also be designed as a one-piece wall. The chamber wall can then be divided accordingly into a first wall part and a second wall part, which are arranged opposite to one another, for example, and together enclose the interior of the chamber. The first wall part can accordingly correspond to the first shell and the second wall part to the second shell. In this case as well, the first wall part can be designed having a higher heat resistance than the second wall part. Likewise, all other statements made for the first and second shells can also be transferred to the first and second wall parts.

However, the design of the chamber wall having two shells that are joined together has the great advantage that this allows simple manufacturing, in particular of the opening device as such and of the entire wall. In general, the opening device can be manufactured separately and inserted into a corresponding opening in the wall and joined to the remaining wall parts of the wall. However, it can also be the case that the opening device, in particular the chamber, is formed as part of the wall when it is produced. This is particularly advantageous if the wall is designed as a cooling device, as explained in more detail later, and also has a multi-layer structure.

It therefore represents a further advantageous embodiment of the invention if the wall is designed as a cooling device and has cooling channels through which a cooling medium can flow. This not only has the advantage that in the course of this the opening device can also be designed easily and integrated into the wall, but also that additional cooling can be provided in this way, on the one hand cooling of the at least one battery cell, and on the other hand also cooling of the channel wall of a gas discharge channel. As a result, the gas flowing through the gas discharge channel can advantageously be cooled. Before the final exit from the motor vehicle, the probability of the gas igniting can be significantly reduced.

It is also very advantageous if the wall is designed in multiple layers, in particular at least in two layers. The individual layers can be provided, for example, by sheets that are joined together to form the cooling channels or cooling channel sections, preferably in a roll bonding method. The wall, and in particular the sheets, can be made of aluminum, for example. Not only cooling channels can be formed here, but also the chambers of the respective opening devices or the at least one chamber described above can be formed in a corresponding manner. For example, the two sheets can be joined together as part of the wall in such a way that the interior of the chamber is formed between them. An opening can then be introduced into the chamber on one side of the wall in order to pour in the substance, in particular the powder mixture. This opening can be provided in the first shell. The opening can then be closed at the same time as the ignition module is introduced into the first shell.

In a further advantageous embodiment of the invention, the wall has an area surrounding the opening area, which has a wall thickness that is greater than a wall thickness of the first shell and/or the second shell. In this way, it can advantageously be achieved that the opening device, in particular the first shell and/or the second shell, are deliberately melted by the triggered exothermic chemical reaction, while the surrounding area of the wall is not destroyed. This allows the opening area to be deliberately opened. Uncontrolled melting away of even further surrounding wall areas can thus advantageously be prevented. In principle, this could also be achieved by the surrounding area consisting of a different material, for example having a significantly higher melting point, than the material from which the shells of the opening device are formed. However, especially if the opening device is to be formed as part of the wall when it is produced, it is advantageous if the shells of the opening device and the rest of the wall are made of the same material and different heat resistances and degrees of robustness are provided, for example, due to separate coatings and/or material thicknesses, in particular as in this case the wall thickness. It may be that the surrounding area has a wall thickness that is greater than a respective wall thickness of the first shell and the second shell, and optionally also greater than the sum of the wall thicknesses of the first shell and the second shell.

Furthermore, the invention also relates to a battery for a motor vehicle, wherein the battery has a wall according to the invention or one of its embodiments.

It is furthermore advantageous if the battery has a battery housing and at least one battery module arranged in the battery housing, which comprises the at least one battery cell, wherein the wall is designed as part of the battery housing and separates an interior of the battery housing from the surroundings of the battery housing, in particular wherein the wall is designed as a housing base of the battery housing. Alternatively or additionally, a cover of the battery housing can also be provided by the wall.

The surroundings of the battery housing can also represent the surroundings of the motor vehicle at the same time or can be provided by a gas discharge channel.

The battery can be, for example, a high-voltage battery. The battery cells can be formed, for example, as lithium-ion cells. In addition, the battery cells can be designed as prismatic battery cells, pouch cells, or round cells. The battery preferably comprises multiple battery modules, wherein each of the battery modules in turn comprises multiple battery cells. The multiple battery cells can be arranged in a common battery housing. The cover and/or the housing base of the battery housing cover all of the cells comprised by the battery. It is therefore very advantageous to design these housing components in particular as the wall through which the gas emerging from a cell is led out in case of degassing or gas emerging in order to introduce it directly into the surroundings of the motor vehicle or into a degassing channel and then discharge it. If the wall, for example the housing base or the cover, is designed at the same time as a cooling device, the cooling channels or cooling channel sections extend in areas of this wall in which accordingly no opening area is provided.

As already described above, it is furthermore preferred if one assigned opening area is provided in the wall per battery cell. This makes it possible to provide targeted, individual gas discharge. However, it is also conceivable if multiple battery cells are assigned to a common opening area.

In a further advantageous embodiment of the invention, the at least one battery cell has a releasable cell degassing opening. This can be provided, for example, as a bursting membrane in a cell housing of the at least one battery cell. Furthermore, it is advantageous if the at least one battery cell is arranged on the wall in such a way that the releasable cell degassing opening is opposite to the opening area of the wall. The gas emerging from the at least one battery cell in case of gas emerging thus strikes the opening area of the wall directly. This can trigger the ignition module described above and thus initiate the exothermic chemical reaction, by which the opening area is melted through so that the gas can penetrate the wall in the opening area unhindered.

Furthermore, the invention also relates to a motor vehicle having a battery according to the invention or one of its embodiments.

The motor vehicle according to the invention is preferably designed as an automobile, in particular as a passenger car or truck, or as a passenger bus or motorcycle.

Furthermore, the invention also relates to a method for the passage of gases emerging from at least one battery cell through a wall with having opening area through which, in case of gas emerging from the at least one battery cell, in which gas emerges from the at least one battery cell, the emerging gas is conducted through the wall. The opening area has an opening device which is fluid-tight in a closed state and which is configured so that an exothermic chemical reaction is triggered by an activation event, by which at least part of the opening device is melted, due to which the opening device passes from the closed state into an open state, in which the gas emerging from the at least one battery cell is conducted through the wall.

The exothermic chemical reaction is also triggered outside the battery cell and, for example, in the opening device in this case. In other words, the exothermic chemical reaction does not mean the thermal runaway of a battery cell or the exothermic chemical reaction that occurs therein when a battery cell thermally runs away.

The invention also includes refinements of the method according to the invention, which have features as already described in the context of the refinements of the wall according to the invention and the battery according to the invention. For this reason, the corresponding refinements of the method according to the invention are not described again here.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic representation of a part of a battery according to an exemplary embodiment of the invention; and

FIG. 2 shows a schematic and perspective cross-sectional representation of an opening device for a wall according to one exemplary embodiment of the invention;

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

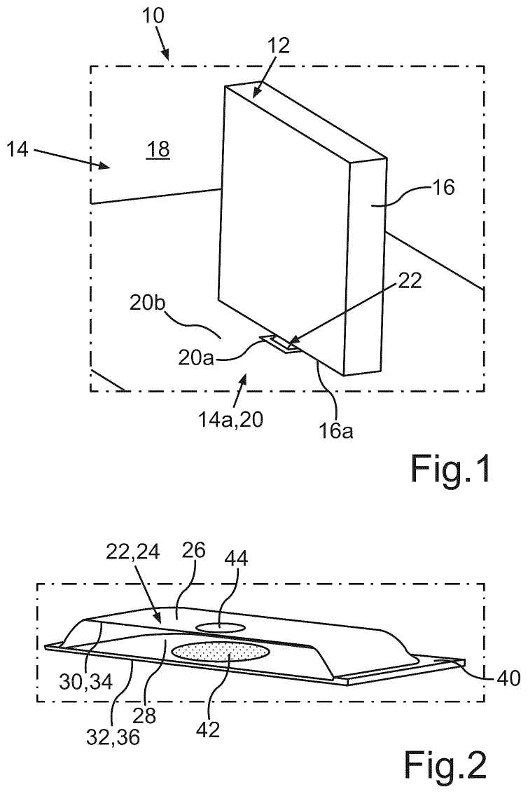

FIG. 1 shows a schematic representation of a part of a battery 10 according to one exemplary embodiment of the invention. The battery 10 is preferably designed as a high-voltage battery for a motor vehicle and comprises multiple battery cells 12, of which only one is shown here as an example. The battery cells 12 can be arranged in a battery housing 14. The battery housing 14 can, for example, have a housing base 14a, which can simultaneously be designed as a cooling base, i.e., can have cooling channels through which a cooling medium can flow. The at least one battery cell 12 is arranged accordingly on the housing base 14a. The battery cell 12 also has a cell housing 16, which comprises a releasable cell degassing opening, which in this example is arranged on a lower side 16a of the cell housing 16 of the battery cell 12. The lower side 16a of the cell housing 16 faces toward the housing base 14a. The releasable cell degassing opening is designed so that in case of a thermal runaway of the battery cell 12, in particular caused by an accompanying increasing internal pressure in the battery cell 12, it is released in order to allow gas to emerge from the battery cell 12. This gas emerging from the cell 12 is then to be able to be reliably discharged from the interior 18 of the battery housing 14, for example into a gas discharge channel or to the surroundings of the motor vehicle in which the battery 10 is arranged. In this example, the housing base 14a simultaneously represents a wall 20 that separates the interior 18 of the battery housing 14 from such a gas discharge channel or the surroundings. In order to enable reliable gas discharge from the battery housing 14, this wall 20 has an opening region 20a in which an opening device 22 is arranged. The opening area 20a can also be restricted to the opening device 22. In addition, this opening area 20a is surrounded by a surrounding area 20b of the wall 20. The wall 20 is preferably designed in such a way that gas passage through the wall 20 is preferably only possible in such an opening area 20a and not in the surrounding area 20b. The surrounding area 20b can, for example, be designed to have a greater wall thickness or to be more robust and heat-resistant in some other way.

FIG. 2 shows a schematic and perspective cross-sectional representation of an opening device 22 for the wall 20 according to one exemplary embodiment of the invention. In particular, this can be the opening device 22 shown in FIG. 1, which will now be explained in more detail with reference to FIG. 2. The opening device 22 is designed as a chamber 24, which has a chamber wall 26 and an interior 28 which is enclosed by the chamber wall 26. The chamber wall 26 is divided into an upper part 30 and a lower part 32. The upper part 30 can, for example, be provided by an upper shell 34 and the lower part 32 by a lower shell 36, which are joined together in an edge area 40. The chamber 26, in particular the chamber parts 30, 32, can also be designed in one piece. A substance 42, in particular a powder mixture, is arranged in the interior 28. In addition, the opening device 22 has a detonator or an ignition module 44. The ignition module 44 is designed to ignite the powder mixture 42, by which a strongly exothermic reaction is induced. The powder mixture 42 can be, for example, a thermite. As a result of such a highly exothermic chemical reaction, temperatures of several hundred degrees, in particular even over 1,000 degrees Celsius, can be reached. This causes the chamber wall 26 to melt, by which the opening area 20a in the wall 20 is opened.

For example, holes into which such an opening module 22 is inserted can be provided in the cover or in the housing base 14a or in the other housing part of the battery housing 14, which are provided for the opening in case of cell degassing. This opening module 22, that is to say the opening device 22, can then be glued, welded, or otherwise joined to the surrounding areas 20b of the wall 20. Alternatively, it is conceivable that this module 22 is also a fixed component of the housing 14 or the housing part, in this example the housing base 14a. In this example, the module 22 comprises an upper and a lower shell 34, 36, which form a cavity 28. This cavity 28 is at least partially filled with the powder mixture 42 already described, which can be set into a metal fire, for example. The powder mixture 42 can be composed of iron and/or aluminum oxide and/or magnesium. To ignite the powder mixture 42, a detonator 44 is inserted into the module 22 facing toward the battery cell 12. This detonator 44 can be triggered either electrically via a control device, for example due to the detection of a cell failure, or via an ignition channel by the hot gas flow of the cell 12. If the powder mixture 42 in the opening module 22 is triggered, it actively burns an opening in the battery housing 14 and thus ensures a safe degassing option out of the system. The upper and lower shells 34, 36 are preferably selected in terms of material selection, i.e., material and material thickness, and coating so that opening to the outside is ensured first, i.e., opening of the lower shell 36 is ensured first.

A further detail of the design is preferably that the battery housing 14 is designed in a thicker material thickness than the material of the opening module 22. This can ensure that a hot gas jet from the outgassing cell 12 can reliably break through the housing, i.e. the chamber wall 26, of the opening module 22.

In case the ignition module 44 is an actuatable ignition module 44, when the cell 12 is triggered, there is also the possibility of triggering further opening modules 22 in the vicinity via the above-mentioned control device, which in particular can also be part of the battery 10. These can then be opened particularly early to enable unhindered outgassing of the neighboring cells if the thermal event spreads to these neighboring cells.

The spark plug 44 can generally have a glow plug or a glow wire or a similar ignition mechanism.

Overall, the examples show how the invention can provide a targeted opening mechanism of battery housings in case of degassing of battery cells by means of a chemical reaction. This allows the creation of a specific opening mechanism which, when cells are degassing, opens the battery housing as close as possible to the cell and thus allows the gases to escape, in particular to the outside or into a degassing channel. This advantageously enables safe and targeted opening of areas of the battery housing for the safe discharge of gases from the cell. This enables the pressure in the battery system to be actively reduced, as well as reducing the distribution of particles in the housing.

1. A wall for arrangement on at least one battery cell and for the passage of gases emerging from the at least one battery cell, wherein the wall has an opening area through which, in case of gas emerging from the at least one battery cell, in which gas emerges from the at least one battery cell, the emerging gas can be conducted through the wall;
wherein the opening area has an opening device which is fluid-tight in a closed state and which is designed to carry out an exothermic chemical reaction triggerable by an activation event, by which at least part of the opening device can be melted, due to which the opening device passes from the closed state into an open state, in which the gas emerging from the at least one battery cell can be conducted through the wall.

2. The wall according to claim 1, wherein the opening device comprises a chamber having an interior and a chamber wall enclosing the interior, in particular made of metallic material, wherein an ignitable substance, in particular a powder mixture, is arranged in the interior, which is designed so that it carries out the exothermic chemical reaction upon ignition.

3. The wall according to claim 1, wherein the activation event represents a heating of the opening device caused by a thermal runaway of the at least one battery cell, in particular wherein an ignition module of the opening device is triggerable by the heating, and the opening device is configured such that the substance is ignitable by triggering the ignition module.

4. The wall according to claim 1, wherein the opening device has an actutable ignition module, wherein the activation event represents an actuation of the ignition module, in particular wherein the ignition module is designed such that, upon actuation, it ignites the substance located in the interior.

5. The wall according to claim 1, wherein the opening device has a first shell and a second shell, each of which provides a part of the chamber wall and which are arranged opposite to one another and, for example, are joined together, wherein the first shell is provided for an arrangement facing toward the battery cell and the second shell is provided for an arrangement facing toward a gas discharge channel or the surroundings of a battery housing in which the at least one battery cell is arranged, wherein the first shell has a higher heat resistance than the second shell.

6. The wall according to claim 1, wherein the wall has an area surrounding the opening area which area has a wall thickness that is greater than a wall thickness of the first shell and/or the second shell.

7. A battery for a motor vehicle having a wall according to claim 1, wherein the battery has a battery housing and at least one battery module arranged in the battery housing which comprises the at least one battery cell, wherein the wall is designed as part of the battery housing and separates an interior of the battery housing from the surroundings of the battery housing, in particular wherein the wall is designed as a housing base of the battery housing.

8. The battery according to claim 7, wherein the at least one battery cell has a releasable cell degassing opening, wherein the at least one battery cell is arranged on the wall in such a way that the releasable cell degassing opening is opposite to the opening area of the wall.

9. A motor vehicle having a battery according to claim 7.

10. A method for the passage of gases emerging from at least one battery cell through a wall having an opening area through which, in case of gas emerging from the at least one battery cell, in which gas emerges from the at least one battery cell, the emerging gas is conducted through the wall;
wherein the opening area has an opening device which is fluid-tight in a closed state and wherein the opening device is designed such that an exothermic chemical reaction is triggered by an activation event, by which at least part of the opening device is melted, due to which the opening device passes from the closed state into an open state, in which the gas emerging from the at least one battery cell is conducted through the wall.

11. The wall according to claim 2, wherein the activation event represents a heating of the opening device caused by a thermal runaway of the at least one battery cell, in particular wherein an ignition module of the opening device is triggerable by the heating, and the opening device is configured such that the substance is ignitable by triggering the ignition module.

12. The wall according to claim 2, wherein the opening device has an actutable ignition module, wherein the activation event represents an actuation of the ignition module, in particular wherein the ignition module is designed such that, upon actuation, it ignites the substance located in the interior.

13. The wall according to claim 3, wherein the opening device has an actutable ignition module, wherein the activation event represents an actuation of the ignition module, in particular wherein the ignition module is designed such that, upon actuation, it ignites the substance located in the interior.

14. The wall according to claim 2, wherein the opening device has a first shell and a second shell, each of which provides a part of the chamber wall and which are arranged opposite to one another and, for example, are joined together, wherein the first shell is provided for an arrangement facing toward the battery cell and the second shell is provided for an arrangement facing toward a gas discharge channel or the surroundings of a battery housing in which the at least one battery cell is arranged, wherein the first shell has a higher heat resistance than the second shell.

15. The wall according to claim 3, wherein the opening device has a first shell and a second shell, each of which provides a part of the chamber wall and which are arranged opposite to one another and, for example, are joined together, wherein the first shell is provided for an arrangement facing toward the battery cell and the second shell is provided for an arrangement facing toward a gas discharge channel or the surroundings of a battery housing in which the at least one battery cell is arranged, wherein the first shell has a higher heat resistance than the second shell.

16. The wall according to claim 4, wherein the opening device has a first shell and a second shell, each of which provides a part of the chamber wall and which are arranged opposite to one another and, for example, are joined together, wherein the first shell is provided for an arrangement facing toward the battery cell and the second shell is provided for an arrangement facing toward a gas discharge channel or the surroundings of a battery housing in which the at least one battery cell is arranged, wherein the first shell has a higher heat resistance than the second shell.

17. The wall according to claim 2, wherein the wall has an area surrounding the opening area which area has a wall thickness that is greater than a wall thickness of the first shell and/or the second shell.

18. The wall according to claim 3, wherein the wall has an area surrounding the opening area which area has a wall thickness that is greater than a wall thickness of the first shell and/or the second shell.

19. The wall according to claim 4, wherein the wall has an area surrounding the opening area which area has a wall thickness that is greater than a wall thickness of the first shell and/or the second shell.

20. The wall according to claim 5, wherein the wall has an area surrounding the opening area which area has a wall thickness that is greater than a wall thickness of the first shell and/or the second shell.
